(19) United States
(12) Patent Application Publication
(10) Pub. No.: US 2016/0254937 A1
(43) Pub. Date: Sep. 1, 2016

(54) LOW COMPLEXITY SCMA/LDS DETECTION SYSTEMS AND METHODS

(71) Applicant: Huawei Technologies Co., Ltd, Guangdong (CN)

(72) Inventors: Alireza Bayesteh, Ottawa (CA); Hosein Nikopour, Ottawa (CA); Mohammadhadi Baligh, Ottawa (CA); Mahmoud Taherzadehboroujeni, Ottawa (CA)

(21) Appl. No.: 14/633,965

(22) Filed: Feb. 27, 2015

(51) Int. Cl. H04L 27/26; H04L 1/00

(52) U.S. Cl. CPC H04L 27/2649; H04L 1/0054

(57) ABSTRACT

Systems and methods of low complexity SCMA/LDS detection are disclosed by performing a detection algorithm such as a Message Passing Algorithm (MPA) in a receiver only over selective sub-graphs of a corresponding full factor graph representative of multiplexed codes for the multiple access code system.

### CROSS-REFERENCE TO RELATED APPLICATIONS

U.S. patent application publication US2014/0140360 published May 22, 2014, assigned to the Assignee of the present disclosure, titled “SYSTEMS AND METHODS FOR SPARSE CODE MULTIPLE ACCESS”, herein incorporated by reference in its entirety, discloses exemplary systems, methods, and devices in which embodiments disclosed herein may be practiced.

### TECHNICAL FIELD

The present disclosure relates generally to Sparse Code Multiple Access (SCMA) and Low Density Signature (LDS) Multiple Access and more particularly to low complexity systems, methods, and devices for SCMA/LDS detection.

### BACKGROUND

CDMA is a well-known multiple access technique in which data symbols are spread out over orthogonal or non-orthogonal code sequences. Multicarrier CDMA (MC-CDMA) takes advantages of both OFDMA and CDMA to enable flexible code domain multiplexing with the simplicity of OFDMA transceiver techniques especially for wideband communication.

### SUMMARY

Low complexity SCMA/LDS detection systems, methods and devices are disclosed. In an embodiment, a SCMA/LDS receiver runs a message passing algorithm only over selective sub-graphs, the sub-graphs approximate an underlying full factor graph that represents a codebook for the multicarrier, multiple access code system.

In an embodiment, the sub-graphs are selected such that least number of branches connect to each function node while similar performance as a full message passing algorithm is achieved.

In an embodiment, sub-graphs are selected which have maximum length of a shortest cycle contained in the sub-graph.

In an embodiment, sub-graphs are selected which include all variable nodes.

In an embodiment, message passing algorithms are only performed on those sub-graphs selected such that the fewest number of branches are connected to each function node but similar performance as a full message passing algorithm is achieved.

In an embodiment, a SCMA/LDS receiver decodes by rotating between the selective sub-graphs for a predetermined number of rotation cycles.

In an alternative instrumentality, combinations for which an EXP(.) function (or Euclidean distance) should be computed are preselected so that substantially the same performance is achieved compared to full EXP(.) calculations.

In another alternative instrumentality, a receiver performs a modified MPA utilizing the fact that the number of projection points over each tone is less than the number of constellation points (a property of the SCMA codebook) while achieving similar performance as a full MPA but with much lower complexity.

Multiple instrumentalities are independent of one another and hence, system benefit may be achieved individually or with a combination of instrumentalities. The features and advantages of the disclosure can be realized and obtained by means set forth in detail herein.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an exemplary prior art full Message Passing Algorithm (MPA) on a full factor graph for determining the probability values at six variable nodes (VNs) from four function nodes (FNs);

FIG. 2 illustrates an exemplary sub-graph of a full factor graph in accordance with the principles of the present disclosure;

FIG. 3 illustrates a flowchart of exemplary but not exhaustive steps for selecting sub-graphs;

FIG. 4 illustrates a sub-graph with one VN excluded;

FIG. 5 illustrates Block Error Ratio (BLER) performance of a Clustered Message Passing Algorithm (CMPA) compared to a full MPA for LDS in a Down Link (DL);

FIG. 6 illustrates Block Error Ratio (BLER) performance of a CMPA compared to an full MPA for SCMA in an UP Link (UL);

FIG. 7 illustrates the projection of each SCMA codebook over each dimension as the rotated version of a set of reference constellation points;

FIG. 8 illustrates exemplary quantization regions for QPSK;

FIG. 9 illustrates the BLER comparison of a selective EXP(.) versus an ideal MPA with optimized parameters;

FIG. 10 illustrates an exemplary four-point codebook of T1003 with the number of projections of constellation points over each tone being three;

FIG. 11 illustrates the BLER performance of an MPA with reduced set of projection points compared to the ideal MPA for SCMA T1008 in UL;

FIG. 12 illustrates an exemplary block diagram of a SCMA/LDS-OFDM system employing a detector practicing principles of the present disclosure; and,

FIG. 13 illustrates an exemplary block diagram of a system having a receiver for practicing principles of the present disclosure.

### DETAILED DESCRIPTION

It may be advantageous to first set forth definitions of certain words and phrases used throughout this disclosure. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like. The term “algorithm” is used herein to describe a method for calculating a function.

As will be appreciated by one skilled in the art, aspects of the present disclosure may be embodied as a method, system, device, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module” or “system”. Field Programmable Gate Arrays (FPGAs), Application Specific Integrated Circuits (ASICs), Digital Signal Processors (DSPs) and general purpose processors alone or in combination, along with associated software, firmware and glue logic may be used to construct the present disclosure.

Unless defined otherwise, all technical and scientific terms used herein have the same meaning as commonly understood by those of skill in the art to which this disclosure pertains. For example, the term sub-channels, subcarriers, and tones are used interchangeably herein.

Sparse Code Multiple Access (SCMA) encoding is a technique that encodes binary data streams directly to multi-dimensional codewords. By directly encoding the binary data to multi-dimensional codewords, the SCMA encoding techniques circumvent QAM symbol mapping, thereby achieving coding gains over conventional CDMA encoding. Notably, SCMA encoding techniques convey binary data using the multi-dimensional codeword, rather than a QAM symbol. Moreover, SCMA encoding techniques provide multiple access through assignment of a different codebook for each multiplexed layer, as opposed to using a unique spreading sequence (e.g., Low Density Signature (LDS)—a special case of multi-carrier CDMA wherein its spreading sequences have low density) as is common in conventional CDMA encoding. Further, the SCMA codebooks comprise sparse codewords such that receivers can use low complexity message passing algorithms (MPAs) to detect their respective codewords amongst the multiplexed codewords, which reduces baseband processing complexity on the receiver side. Multiple SCMA layers share the same time-frequency resources of OFDMA. The sparsity of codewords makes near-optimal detection feasible through an iterative MPA. Such low complexity of multi-layer detection allows excessive codeword overloading in which the dimension of multiplexed layers exceeds the dimension of codewords. Optimization of the overloading factor along with modulation-coding levels of layers provides a more flexible and efficient link adaptation mechanism. The signal spreading feature of SCMA improves link-adaptation as a result of less colored interference.

Although complexity is reduced by using a MPA, decoding is still very complex for longer sequences and/or higher overloading factors (e.g. for massive connectivity or Coordinated Multi-Point (CoMP) applications).

By reducing the decoding complexity, delay, cost, and receiver power consumption is reduced. Therefore, there is a need for low complexity decoding systems, methods, and devices for SCMA/LDS while having similar performance to a decoder employing a full MPA.

Sparse Code Multiple Access (SCMA) code can be represented by a factor graph matrix defined as: F=(f₁, . . . , f_{J}), where fⱼ, j=1, . . . , J represents a binary vector of size K, in which J represents the total number of variable nodes (VNs) and K represents the total number of function nodes (FNs). Variable node j and function node k are connected if and only if (F)kj=1.

As will be appreciated by those skilled in the art, factor graphs are graphical representations of complex functions—that is, representations of how variables of a global function are grouped together locally. These graphical methods have arisen as a description of the structure of probabilistic networks, where one of their primary purposes is to provide a simple visualization of probabilistic dependencies.

Factor graphs describe the network of connections among variables by edges between nodes, along which probabilities can be exchanged locally with the purpose of calculating global probabilistic functions. The factor graph represents a blueprint for a computational machine that evaluates the global function via local processing such as in a baseband processor in a handset or in the base station.

Factor graphs are bipartite graphs wherein their nodes fall into just two groups such that there are no connections inside each group, but only between nodes in different groups. These groups are referred to as variable nodes (VN) and function nodes (FN). In the present disclosure, the VNs represent the SCMA layers whereas the FNs represent the tones over which the layers are mapped.

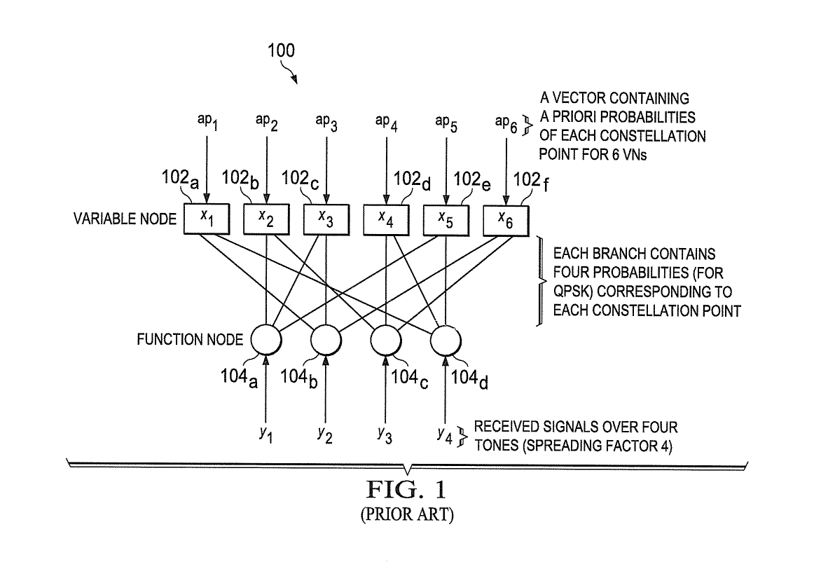

An example of the factor graph representation for F is illustrated in FIG. 1 with six VNs and four FNs representing six layers mapped over four tones. The majority of SCMA decoding complexity is due to computations at the FNs. Accordingly, reducing the number of branches connected to each FN in the factor graph significantly reduces the overall complexity of the Message Passing Algorithm (MPA).

FIG. 1 illustrates an exemplary prior art MPA 100 implementing an iterative algorithm to determine the probability values at the six VNs 102ₐ-102_{f} from the four FNs 104ₐ-104_{d}. Hereinafter the MPA 100 of FIG. 1 is referred to as a “full” or an “ideal” MPA. Initially a vector containing a priori (ap) probabilities is used for each of the six VNs 102ₐ-102_{f}. The six initial vectors for the six VNs 102ₐ-102_{f} are labeled ap1, ap2, ap3, ap4, ap5, ap6.

The MPA 100 iteratively updates the values at FNs 104ₐ-104_{d} according to the values sent from the VNs 102ₐ-102_{f} (starting from the initial ap values) and subsequently uses the updated values at FNs 104ₐ-104_{d} to update the values at the VNs 102ₐ-102_{f}. Updating the vectors or values back and forth between the VNs 102ₐ-102_{f} and the FNs 104ₐ-104_{d} is referred to as message passing or exchange between the two node sets. This back and forth information passing between the FNs 104ₐ-104_{d} and the VNs 102ₐ-102_{f} is repeated until the probability values at the VNs 102ₐ-102_{f} converge to a solution. The converged probability values at the VNs 102ₐ-102_{f} are then processed to determine each of the six symbols. Additional information concerning MPAs is provided by Hoshyar, et al., in “Novel Low-Density Signature for Synchronous CDMA Systems Over AWGN Channel,” IEEE Transactions on Signal Processing, Vol. 56, No. 4, April 2008, and by Hoshyar, et al., in “Efficient Multiple Access Technique,” IEEE 71st VTC 2010, pp. 1-5, U.S. patent application publication US2014/0169408 published Jun. 19, 2014, titled “SYSTEM AND METHOD FOR OPEN-LOOP MIMO COMMUNICATION IN A SCMA COMMUNICATIONS SYSTEM” to Bayesteh et al., and assigned to the Assignee of the present disclosure, and U.S. patent application publication US2014/0169409 published Jun. 19, 2014, titled “SYSTEMS AND METHODS FOR OPEN-LOOP SPATIAL MULTIPLEXING SCHEMES FOR RADIO ACCESS VIRTUALIZATION” to Ma et al. and assigned to the Assignee of the present disclosure, all of said references are herein incorporated by reference in their entirety.

Reference is now made to FIG. 2 illustrating an exemplary sub-graph 200 of the factor graph 100 illustrated in FIG. 1. The dashed branches in sub-graph 200 represent those branches which are removed from the factor graph 100 depicted in FIG. 1.

According to the present disclosure, sub-graphs are selected such that less number of branches connect to each FN while providing similar performance as a MPA on a full factor graph. The running of a MPA only over sub-graphs rather than a full factor graph is hereinafter referred to as a clustered MPA (CMPA). The sub-graphs are selected such that the number of branches connected to each FN is reduced to a predefined number. The predefined number of branches is determined by the constraint on the MPA. For this purpose, the list of all possible clusters are first considered. For example in FIG. 2, if the number of branches connected to each FN (y₁-y₄) is limited to two, a total of eighty-one clusters are defined. That is, since three branches are connected to each FN and one branch from each FN is desired to be removed, three options for removing one branch connected to each FN exist. In the present example there are four FNs, thus a total of 3⁴ (i.e. eighty one) different options exist for constructing the sub-graph in which the number of branches connected to each FN (y₁-y₄) is 2.

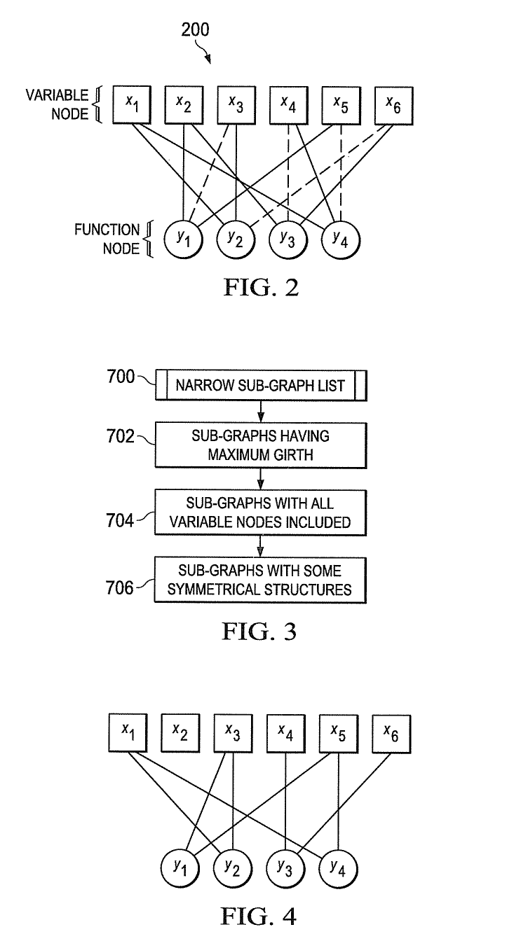

Once an underlying factor graph is established for a selected number of layers and tones, a set of sub-graphs are determined/selected that provide similar performance as the full factor graph. FIG. 3 illustrates a flowchart of exemplary but not exclusive steps for narrowing down the list of suitable sub-graphs for calculation. The process 700 for narrowing the sub-graph list may include step 702 wherein sub-graphs are selected which have maximum length of a shortest cycle contained in the sub-graph. Such sub-graphs are said to maximize the girth. At step 704, sub-graphs that include all the VNs may be selected. Applicants have found through experimentation and simulation that selecting sub-graphs which exclude one or more VNs results in performance degradation thus indicating that including sub-graphs having all the VNs is desirable. An example of a sub-graph excluding a VN is illustrated in FIG. 4 in which VN x₂ is excluded. At step 706, sub-graphs having some symmetrical structures may be selected. Applicants have found through experimentation and simulation that symmetrical structures for sub-graphs result in more uniform performance for different layers. It should be understood that FIG. 3 is only illustrative and not exhaustive, and that those having ordinary skill in the art will appreciate other steps or techniques for narrowing down the list of suitable sub-graphs for MPA calculation without departing from the scope of the present invention.

In general, factor graphs for different number of VNs and FNs (i.e. layers and tones) may be generated and the optimum sub-graphs for each can be simulated/selected offline (such as in a computer workstation using principles of FIG. 3), and stored in a look up table in the receiving device such as a handset or base station, for use in decoding.

In the receiving device, a cluster MPA (CMPA) is run over each selected sub-graph which may be stored in memory. A CMPA is similar to the MPA depicted in FIG. 1 except that one-way information flow is made over the dashed (removed) branches in the sub-graphs. More particularly, VN to FN information is passed like a regular MPA but FN to VN information is not passed over the dashed branches. This means that the operations at VNs is the same as in the regular MPA, however, the operations at FNs are reduced to only the solid branches and the dashed branches are ignored. The computational complexity at VNs are much lower than FNs and for the case of dᵥ=2 (i.e. two branches are connected to each VN), VNs normalize the probabilities and forward them to the connected FNs.

Reducing a branch at FNs however, reduces the computational complexity at FNs by an order of magnitude reducing the decoding complexity thus reducing delay, cost, and receiver power consumption. The exponential terms are weighted according to the passed information from the dashed branches. The operations at FN₁ for the sub-graph depicted in FIG. 2 can be written as:

I_{c}_{₁}_{→u}_{₅}(xₘ)=Σₓ_{₂}f(x₂,xₘ)·Iᵤ_{₂}_{→c}_{₁}(x₂), (1)

Where: EXP(.) is shorthand for the function e raised to the power of x (e^{x})—where e is a constant approximately equal to 2.718281828 and xₘ denotes the m^{th} constellation point, m=1, . . . , M, f(x₂,xₘ) denotes the weighted EXP(.) functions obtained from

$$f ( {x}_{2} , {x}_{m} ) = {Σ}_{{x}_{3}} exp ( - \frac{1}{2 {σ}^{2}} {‖ y - {h}_{2} {x}_{2} - {h}_{5} {x}_{m} - {h}_{3} {x}_{3} ‖}^{2} ) {I}_{{u}_{3} \to {c}_{1}} ( {x}_{3} ) .$$

A CMPA is run for each sub-graph and continues to run on subsequent sub-graphs based on a pre-determined order. This is called sub-graph rotation. The VN probabilities obtained from running MPA over previous sub-graphs act as a priori probabilities for the next sub-graph for which CMPA is going to be run over. This procedure is continued for a predetermined number of rotation cycles or until the probabilities converge.

A CMPA early termination mechanism can also be enabled for any of the sub-graphs based on a pre-defined convergence metric, similar to those used in a regular MPA. Furthermore, unnecessary calculations can also be skipped for sufficiently small terms.

Link-level simulation was performed to evaluate the performance of CMPA compared to an ideal MPA. A simulator such as, but not limited to, MATLAB® from The MathWorks, Inc., 3 Apple Hill Drive, Natick, Mass., was used for simulation. For this purpose, both LDS and SCMA detection using CMPA were considered. For CMPA, it was assumed that all of the selected sub-graphs include two branches connected to each FN. Simulation parameters for a LDS scenario are given in Table 1 below.

TABLE 1
Simulation Assumptions for Performance Evaluation
of LDS detection in Down Link with CMPA

| Parameter | Value |
|---|---|
| Antenna Configuration | 1 × 2 (SIMO), DL |
| Number of layers | 6 |
| Resource Allocation | 4 RBs Distributed |
| Modulation and coding | LDS QPSK 1/2 |
| Signature Matrix | $[ \begin{matrix}0 & 1 & {e}^{\frac{2 π i}{3}} & 0 & {e}^{\frac{π i}{3}} & 0 \\ 1 & 0 & {e}^{\frac{π i}{3}} & 0 & 0 & {e}^{\frac{2 π i}{3}} \\ 0 & 1 & 0 & {e}^{\frac{π i}{3}} & 0 & {e}^{\frac{2 π i}{3}} \\ 1 & 0 & 0 & {e}^{\frac{π i}{3}} & {e}^{\frac{2 π i}{3}} & 0\end{matrix} ]$ |
| Receiver | MPA with Outer-loop |
| | (maximum 7 outer-loop iterations) |
| Channel Model | Jakes PB, 3 km/h, BW = 10 MHz |
| Channel Estimation | Perfect |

For CMPA, fifteen sub-graphs were assumed. Sub-graphs were selected based on the process depicted in FIG. 3. Sub-graph rotation was performed after every iteration. Early termination was also enabled.

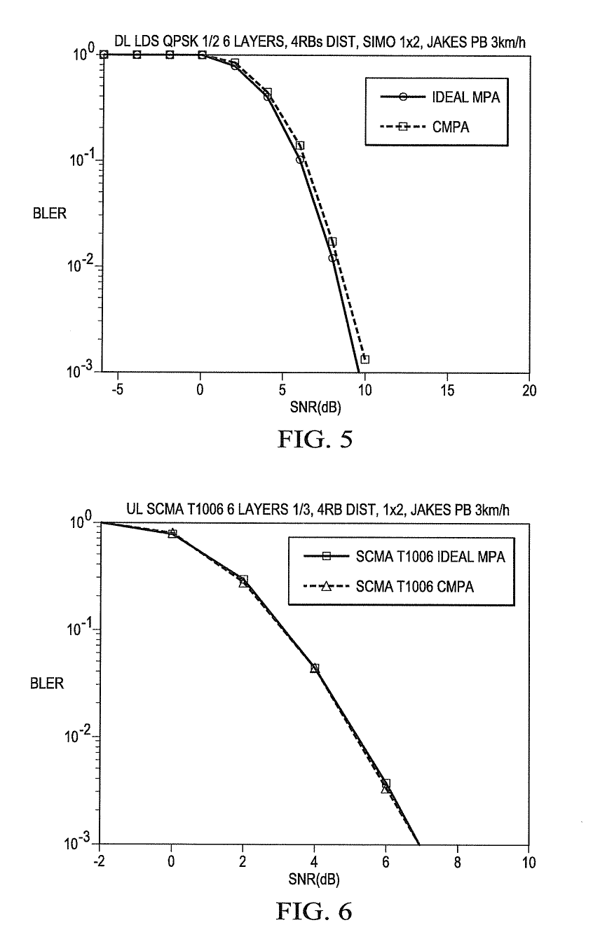

FIG. 5 illustrates Block Error Ratio (BLER) performance of a CMPA compared to an ideal MPA for LDS in a Down Link (DL). As can be observed from FIG. 5, CMPA achieves similar performance of an ideal MPA with negligible performance loss for LDS detection in the DL.

Simulation parameters for a SCMA scenario are given in Table 2 below.

TABLE 2

| Parameter | Value |
|---|---|
| Antenna | 1 × 2 (SIMO), UL |
| Configuration | |
| Number of layers | 6 |
| Resource Allocation | 4 RBs Distributed |
| Modulation and | SCMA T1006 ⅓ |
| coding | |
| Receiver | MPA with Outer-loop (maximum 7 outer-loop |
| | iterations) |
| Channel Model | Jakes PB, 3 km/h, BW = 10 MHz |
| Channel Estimation | Perfect |

For CMPA, fifteen sub-graphs were assumed. Sub-graphs were selected based on the process depicted in FIG. 3. Sub-graph rotation was performed after every iteration. Early termination was also enabled.

FIG. 6 illustrates BLER performance of a CMPA compared to an ideal MPA for SCMA in an UP Link (UL). As depicted in FIG. 6, CMPA achieves similar performance of an ideal MPA with substantially no performance loss for SCMA detection in the UL.

The sources of complexity for SCMA/LDS detection are:
1) The computational complexity per MPA iteration;
2) The number of required (internal) MPA iterations in order for the probabilities to converge; and,
3) The number of required outer-loop iterations.

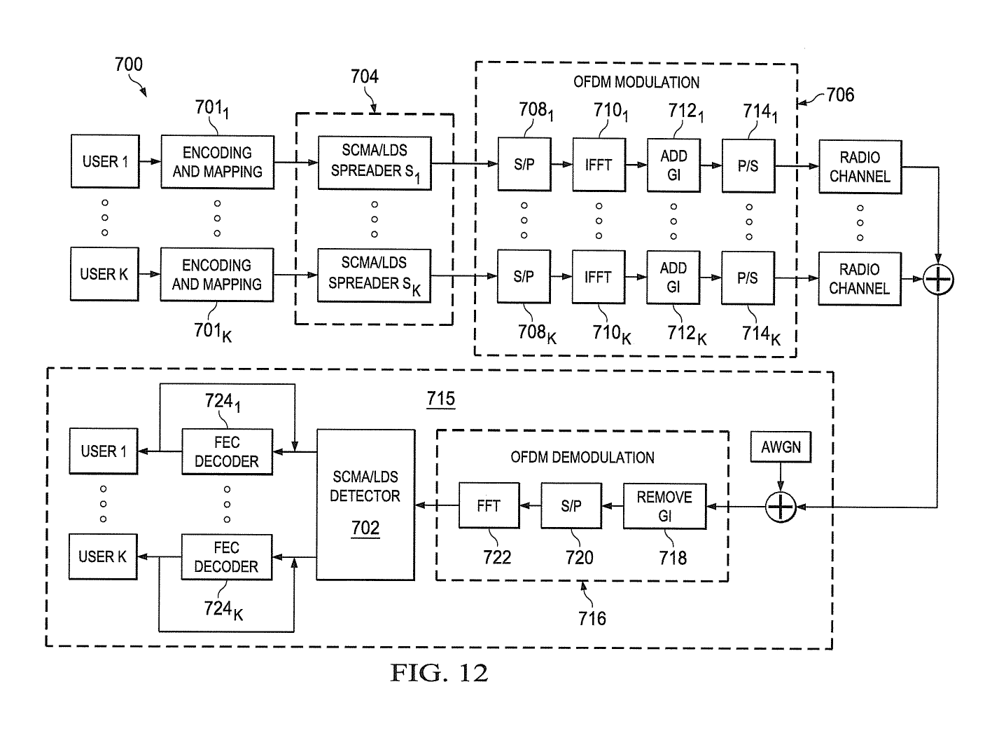

Applicants have found through experimentation and simulation that CMPA does not imply any substantial change in terms of the number of required (internal) MPA iterations or the number of required outer-loop iterations (see FIG. 12). Therefore, only the complexity of CMPA in terms of the computational complexity for each MPA iteration were considered.

In a regular MPA, the sources of complexity for each MPA iteration are the computational complexity at the VNs and FNs. Computational complexity at the VNs includes addition and multiplication. This complexity is the same for CMPA and MPA as the functionality of VNs does not substantially change. However, VN complexity is negligible compared to FN complexity. Accordingly, VN complexity was disregarded and only the FN complexity considered.

Computational complexity at FNs includes addition, multiplication and the EXP(.) computation (recalling that EXP(.) is shorthand for the function e raised to the power of x (e^{x})—where e is a constant approximately equal to 2.718281828). The EXP(.) computation is performed once for the entire SCMA/LDS decoding.

It is assumed that at each FN, d_{f}^{(I)} number of dashed branches exist for which no information is passed from FN wherein d_{f} denotes the total number of branches connected to each FN, N denotes the number of FNs (i.e. spreading factor), and M is the size of constellation points. The number of additions, multiplications, and EXP(.) calculations can be obtained from:

N_{add}=N(d_{f}−d_{f}^{(I)})(M^{d}^{_{f}}^{-d}^{_{f}}^{^{(I)}}−M), (2)

Nₘᵤₗ=N(d_{f}−d_{f}^{(I)})M^{d}^{_{f}}^{-d}^{_{f}}^{^{(I)}}⁻¹(d_{f}−d_{f}^{(I)}−2+M), (3)

N_{EXP}=M^{d}^{^{f}}. (4)

In another embodiment, MPA implementation is simplified by using Max-Log MAP (MLM) instead of calculating the sum in equation (1). This is accomplished by calculating log(.) of equation (1) and approximating the log of the sum of EXP(.) terms by MAX(.) of those terms. This converts multiplication to addition and the EXP(.) calculation to a MAX(.) operation. Hence,

N_{add}^{(MLM)}=N(d_{f}−d_{f}^{(I)})M^{d}^{_{f}}^{-d}^{_{f}}^{^{(I)}}⁻¹(d_{f}−d_{f}^{(I)}−2+M), (5)

N_{MAX}^{(MLM)}=M^{d}^{_{f}}. (6)

Tables 3 and 4 below compare the complexity reduction of CMPA compared to MPA for four and eight point SCMA constellations for the original algorithm and Max-Log MAP implementation of MPA. It was assumed that all selected sub-graphs include two branches connected to each FN, i.e. d_{f}^{(I)}=1. The total complexity is defined as N_{add}+3Nₘᵤₗ 10N_{EXP} for regular implementation and N_{add}^{(MLM)}+1.5N_{MAX}^{(MLM)} for Max-Log MAP implementation of MPA.

TABLE 3
Complexity reduction of CMPA compared to MPA for original
implementation

| Four-point | | | Eight-point | | |
|---|---|---|---|---|---|
| | | Total | Saving | Saving | Total |
| Saving in | Saving in | Saving | in Mul | in Add | Saving |
| Mul (%) | Add (%) | (%) | (%) | (%) | (%) |
| 87 | 87 | 84 | 93 | 93 | 91 |

TABLE 4
Complexity reduction of CMPA compared
to MPA for Max-Log MAP implementation

| | |
|---|---|
| Four-point | Eight-point |

| Saving | Total | Saving | Total |
|---|---|---|---|
| in Add | Saving | in Add | Saving |
| (%) | (%) | (%) | (%) |
| 87 | 85 | 93 | 92 |

In alternative complexity reduction SCMA/LDS detection systems and methods, combinations are preselected for which the EXP(.) function (or Euclidean distance) is computed such that substantially similar performance is achieved compared to a full EXP(.) calculation.

Looking at the EXP(.) terms at FN n:

$$exp ( - \frac{1}{2 {σ}^{2}} {‖ {y}_{n} - {Σ}_{k ∈ {V}_{n}} {h}_{k , n} {x}_{k} ‖}^{2} ) \qquad ( 7 )$$

The combinations for {xₖ}_{kεV}_{ₙ} are selected for which the term

$$exp ( - \frac{1}{2 {σ}^{2}} {‖ {y}_{n} - {Σ}_{k ∈ {V}_{n}} {h}_{k , n} {x}_{k} ‖}^{2} )$$

is sufficiently large to consider those combinations for further computations at FN. A process hereinafter referred to as “SelEXP”, identifies those combinations that are sufficiently large to consider without the need to calculate yₙ−Σ_{kεV}_{ₙ}h_{k,n}xₖ for all combinations. The complexity reduction of SelEXP linearly decreases the operational complexity at FNs as the computations for the non-useful combinations are skipped.

The distance term is decomposed into two terms namely, one of the h_{k,n}xₖ terms (denoted by h_{k*,n}x_{k*}) and the rest of the terms: yₙ−Σ_{kεV}_{ₙ}_{,k≠k*}h_{k,n} xₖ.

SelEXP is now described for a single receiver antenna case, i.e. h_{k,n}'s are complex scalars. The EXP(.) term is written as:

$$exp ( - \frac{1}{2 {σ}^{2}} {‖ {y}_{n} - {Σ}_{k ∈ {V}_{n}} {h}_{k , n} {x}_{k} ‖}^{2} ) = exp ( - \frac{1}{2 {σ}^{2}} {‖ \overbrace{{e}^{- ( {φ}_{h} + {φ}_{x} )} ( {y}_{n} - {Σ}_{k ∈ {V}_{n} , k \neq {k}^{*}} {h}_{k , n} {x}_{k} )}^{A} - \vert {h}_{{k}^{*} , n} \vert {x}_{R} ‖}^{2} ) , \qquad ( 8 )$$

Where x_{R} represents the “reference” constellation points, φₕ=phase(h_{k*,n}), φₓ=phase(x_{R})−phase(x_{k*}).

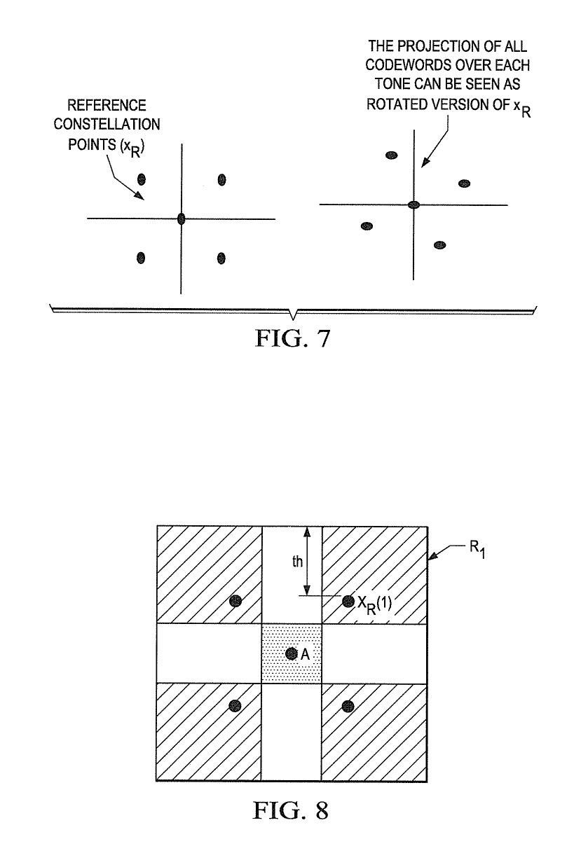

Reference is now made to FIG. 7 that illustrates the projection of the SCMA codebook over each dimension for SCMA as the rotated version of a reference constellation point x_{R}. It should be noted that for LDS, φₓ=0.

The quantization regions are identified by defining a region for each of the scaled reference constellation points x*_{R}=|h_{k*,n}|x_{R}. The simplest regions are rectangular regions. For example, for the QPSK modulation, regions can be defined as follows:

[symbol]

={y∥Re(y)−Re(x*_{R}(i))|<th,|Im(y)−Im(x*_{R}(i))|<th}.

The parameter th controls the size of the regions and hence, the complexity reduction percentage of the algorithm. The lower th is—the more reduction of complexity. These regions are depicted in the FIG. 8.

Useful combinations are determined by calculating the term A in equation (8) above for all combinations {xₖ}_{kεV}_{ₙ}_{,k≠k*}. These terms are denoted by A_{c}, for c=1, . . . , M^{|V}^{ₙ}^{|-1}. The useful combinations of x_{k*} for each term A_{c} that EXP(.) should be calculated for, denoted by U_{k*}(c), are obtained from:

U_{k*}(c)={i|A_{c}ε [symbol] ᵢ} (9)

If the above set is empty, EXP(.) is not computed for that particular combination of {xₖ}_{kεV}_{ₙ}_{,k≠k*}. For the example illustrated in FIG. 8,
If A_{c} falls in the dotted region, then EXP(.) is calculated for all combinations.
If A_{c} falls in the unfilled regions, EXP(.) is calculated for the corresponding two points.
If A_{c} falls in the hatched regions, then EXP(.) is calculated for the corresponding point.
Otherwise, the EXP(.) is not calculated.

Two solutions exist for identifying the useful combinations that EXP(.) should be computed for with multiple receive antennas.

Solution 1: U(t), t=1, . . . , N_{R}, is denoted as the set of combinations EXP(.) terms are computed for over the t-th receive antenna. The final set of combinations EXP(.) terms are computed for are defined as the intersection of U(t) over all receive antennas, i.e. U=∩ₜ₌₁^{N}^{_{R}}U(t).

Solution 2: The maximum ratio combination of the received signals over all antennas follows the subsequent process to find the set of combinations of EXP(.) terms that should be computed. More precisely, the terms A in equation (8) can be computed from:

A=e^{-φ}^{ₓ}(h_{k*,n}^{H}yₙ−Σ_{kεV}_{ₙ}_{,k≠k*}h_{k*,n}^{H}h_{k,n}xₖ),

The scaled reference constellation points are defined as x*_{R}=∥h_{k*,n}∥²x_{R}. The remaining method is the same as the single antenna receiver case.

The disclosed process works for any arbitrary selection of k* among all VNs connected to a FN. The process is further optimized by selecting the best choice for k*. One option is to select the one with the largest ∥h_{k,n}∥, i.e. k*=arg maxₖ∥h_{k,n}∥, which maximizes the minimum distance between the points of the expanded reference constellation points and consequently, selecting the useful combinations more efficiently.

Link-level simulation results illustrate the performance and complexity of the SelEX method. Complexity is defined as the average number of combinations for which EXP(.) is calculated normalized by the total number of combinations. From equation (9), complexity reduction percentage (CRP) is computed from:

$$CRP = \frac{\overline{{\sum }_{c = 1}^{{M}^{\vert {V}_{n} \vert - 1}} \vert {U}_{{k}^{*}} ( c ) \vert}}{{M}^{\vert {V}_{n} \vert}} , \qquad ( 10 )$$

Where x̅ denotes the average of x. As the method works for both UL and DL scenarios, BLER simulation results for DL are introduced. The simulation parameters are summarized in the following table 5.

TABLE 5
Simulation parameters for the SelEXP2
performance evaluation in DL

| Parameter | Value |
|---|---|
| Antenna Configuration | 1 × 2 (SIMO), DL |
| Number of layers | 6 |
| Resource Allocation | 4 RBs Distributed |
| Modulation and coding | LDS QPSK 1/2 |
| Signature Matrix | $[ \begin{matrix}0 & 1 & {e}^{\frac{2 π i}{3}} & 0 & {e}^{\frac{π i}{3}} & 0 \\ 1 & 0 & {e}^{\frac{π i}{3}} & 0 & 0 & {e}^{\frac{2 π i}{3}} \\ 0 & 1 & 0 & {e}^{\frac{π i}{3}} & 0 & {e}^{\frac{2 π i}{3}} \\ 1 & 0 & 0 & {e}^{\frac{π i}{3}} & {e}^{\frac{2 π i}{3}} & 0\end{matrix} ]$ |
| Receiver | MPA with Outer-loop |
| | (maximum 7 outer-loop iterations) |
| Channel Model | Jakes PB, 3 km/h, BW = 10 MHz |
| Channel Estimation | Perfect |

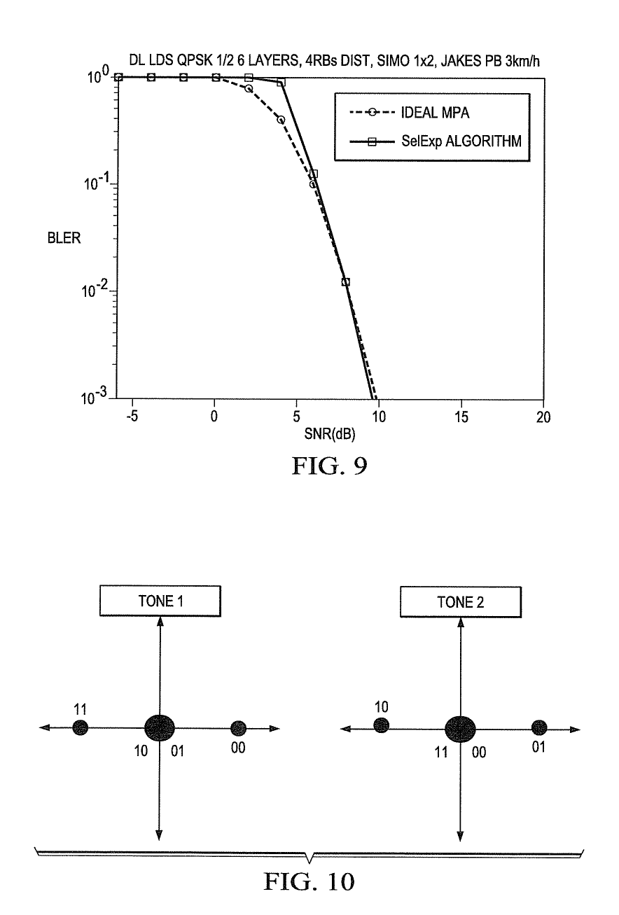

Reference is now made to FIG. 9, illustrating the BLER comparison of SelEXP versus the ideal MPA with optimized parameters. The BLER results are given for optimized value of th such that the best tradeoff between performance and complexity is realized. The performance of a full MPA is substantially obtained with a complexity reduction percentage of 63%.

One of the advantages of SCMA over LDS is that the number of projections of codewords over different tones can be less than the number of constellation points. This property can be seen in some of the proposed SCMA codebooks. For example, FIG. 10 illustrates this for T1003 where the number of projection points over each tone is three (instead of four). The lower number of projections results in a lower number of EXP(.) calculations. However, the full MPA does not take advantage of this property in the operations at FN.

Therefore in another alternative instrumentality, a receiver performs a modified MPA utilizing the fact that the number of projection points over each tone is less than the number of constellation points (a property of the SCMA codebook) while achieving similar performance as a full MPA but with much lower complexity.

The projections of the codewords of VN k over tone n are denoted by the set P_{k,n}=(P_{k,n}⁽¹⁾, . . . , P_{k,n}^{(M)}) in which P_{k,n}^{(m)} denotes the projection of the m-th codeword of VN k over tone n and suppose that some elements in this vector are the same. T_{k,n} is denoted as the indices corresponding to the repetitive projection points in P_{k,n}, i.e. P_{k,n}⁽ⁱ⁾=P_{k,n}^{(j)} [symbol] c_{k,n}, ∀i,jεT_{k,n}. The operations at FN n is expressed as:

$${I}_{{c}_{n} \to {u}_{k}} ( i ) = {\sum }_{{{x}^{[ n ]}}_{{x}_{k} = {𝕌}^{( i )}}} \frac{1}{\sqrt{2 {πσ}^{2}}} exp ( - \frac{1}{2 {σ}^{2}} {‖ {y}_{n} - {Σ}_{k ∈ {V}_{n}} {h}_{k , n} {x}_{k} ‖}^{2} ) {\prod }_{m ∈ V ( n ) \backslash k} {I}_{{u}_{m} \to {c}_{n}} ( {x}_{m} ) , \\ i = 1 , … , M \qquad ( 11 )$$

To better understand the instrumentality having a MPA for reduced set of projection points hereinafter referred to as “ProjMPA”, two observations are made.

Calculation at FNs:

Consider a VN m*εV(n)\k. The right hand side of equation (11) can be expressed as:

$${\sum }_{{{x}^{[ n ]}}_{{x}_{k} = {𝕌}^{( i )} , {x}_{{m}^{*}} = {c}_{k , n}}} \frac{1}{\sqrt{2 {πσ}^{2}}} exp ( - \frac{1}{2 {σ}^{2}} {‖ {y}_{n} - {h}_{{m}^{*} , n} {c}_{k , n} - {Σ}_{k ∈ {V}_{n} \backslash {m}^{*}} {h}_{k , n} {x}_{k} ‖}^{2} ) {I}_{{u}_{{m}^{*}} \to {c}_{n}} ( {c}_{k , n} ) {\prod }_{m ∈ V ( n ) \backslash k , {m}^{*}} {I}_{{u}_{m} \to {c}_{n}} ( {x}_{m} ) + {\sum }_{{{x}^{[ n ]}}_{{x}_{k} = {𝕌}^{( i )} , {x}_{{m}^{*}} \neq {c}_{k , n}}} \frac{1}{\sqrt{2 {πσ}^{2}}} exp ( - \frac{1}{2 {σ}^{2}} {‖ {y}_{n} - {Σ}_{k ∈ {V}_{n}} {h}_{k , n} {x}_{k} ‖}^{2} ) {I}_{{u}_{{m}^{*}} \to {c}_{n}} ( {x}_{{m}^{*}} ) {\prod }_{m ∈ V ( n ) \backslash k , {m}^{*}} {I}_{{u}_{m} \to {c}_{n}} ( {x}_{m} ) .$$

Looking at the first term, Π_{mεV(n)\k,m*}Iᵤ_{ₘ}_{→c}_{ₙ}(xₘ) does not depend on m* and is treated as a constant term in terms of m* and the terms yₙ−h_{m*,n}c_{k,n}−Σ_{kεV}_{ₙ}_{\m*}h_{k,n}xₖ are the same for all values of xₘ*=c_{k,n}.

Thus, the first term is expressed as:

$${\sum }_{{x}_{{m}^{*}} = {c}_{k , n}} {I}_{{u}_{{m}^{*}} \to {c}_{n}} ( {c}_{k , n} ) {\sum }_{{{x}^{[ n ] \backslash {x}_{{m}^{*}}}}_{{x}_{k} = {𝕌}^{( i )}}} \frac{1}{\sqrt{2 {πσ}^{2}}} exp ( - \frac{1}{2 {σ}^{2}} {‖ {y}_{n} - {h}_{{m}^{*} , n} {c}_{k , n} - {Σ}_{k ∈ {V}_{n} \backslash {m}^{*}} {h}_{k , n} {x}_{k} ‖}^{2} ) {\prod }_{m ∈ V ( n ) \backslash k , {m}^{*}} {I}_{{u}_{m} \to {c}_{n}} ( {x}_{m} ) .$$

In other words, from the perspective of FN, the codeword indices in T_{k,n} are considered as a single codeword with the probability equal to the summation of the probabilities of the codewords in T_{k,n}.

Passing Information from FN to VN:

Consider the probabilities I_{c}_{ₙ}_{→u}_{ₖ}(i) and I_{c}_{ₙ}_{→u}_{ₖ}(j) to be passed from FN n to VN k for i,jεT_{k,n}.

$${I}_{{c}_{{n}^{*}} \to {u}_{k}} ( i ) {\sum }_{{x}^{[ n ] \backslash {x}_{k}}} \frac{1}{\sqrt{2 {πσ}^{2}}} exp ( - \frac{1}{2 {σ}^{2}} {‖ {y}_{n} - {h}_{k , n} {c}_{k , n} - {Σ}_{l ∈ {V}_{n} \backslash k} {h}_{l , n} {x}_{l} ‖}^{2} ) {\prod }_{m ∈ V ( n ) \backslash k} {I}_{{u}_{m} \to {c}_{n}} ( {x}_{m} ) ,$$

This is the same as I_{c}_{ₙ}_{→u}_{ₖ}(j). Therefore, the output probabilities passed from FN to VN is the same for all indices in T_{k,n}.

From the above observations, the following four step ProjMPA algorithm is provided. 1) Operation at VN is the same as a regular MPA. 2) There is an additional step when passing information from VN k to FN n which shrinks the probability vector from size M to size M−|T_{k,n}|+1. This is accomplished by removing all indices in T_{k,n} except one and setting the probability of this element as a sum of probabilities of the indices in T_{k,n}. This means that the probability space seen at FN n is (M−|T_{k,n}|+1)-dimensional instead of M-dimensional. 3) The operation complexity at FN is significantly reduced as the probability vectors are of size M−|T_{k,n}|+1 instead of M. 4) As the probability space at FN n is (M−|T_{k,n}|+1)-dimensional while the probability space at VN k is M-dimensional, the probability vector to be passed from FN to VN needs to be expanded. This is accomplished by dividing the probability value of the repetitive component by |T_{k,n}|, and assigning the value to all indices in |T_{k,n}|. This is the reverse of the operation of passing information from VN k to FN n.

The ProjMPA algorithm has two additional steps compared to the regular MPA. However, the complexity of steps 2 and 4 is very low (one multiplication and couple of additions), while the complexity of step 3 (computations at FN) is significantly reduced due to lower size of probability vectors.

Applicants have performed link-level simulation to evaluate the performance of ProjMPA compared to an ideal MPA and to verify the validity of the analysis above. An eight-point codebook of T1008 was considered, which has five projection points over each tone. Details of the simulation setup are given in the following table 6:

TABLE 6
Simulation Assumptions for Performance
Evaluation of ProjMPA

| Parameter | Value |
|---|---|
| Antenna | 1 × 2 (SIMO), UL |
| Configuration | |
| Number of layers | 6 |
| Resource Allocation | 4 RBs Distributed |
| Modulation and | SCMA T1008 ½ |
| coding | |
| Receiver | MPA with Outer-loop |
| | (2 outer-loop |
| | iterations) |
| Channel Model | Jakes PB, 3 km/h, |
| | BW = 10 MHz |
| Channel Estimation | Perfect |

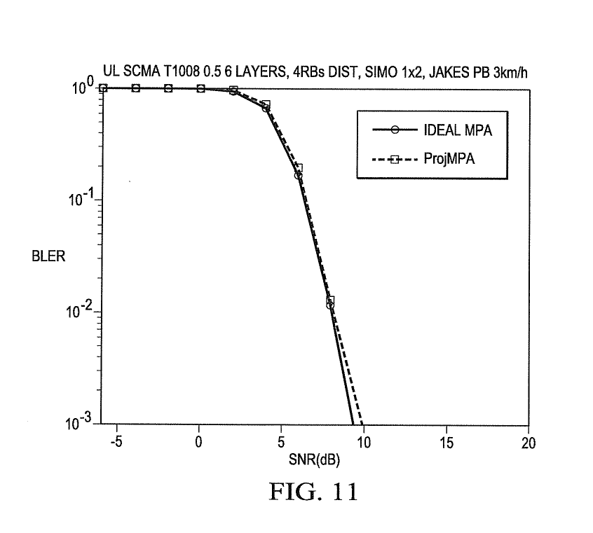

FIG. 11 illustrates BLER performance of ProjMPA compared to the ideal MPA for SCMA T1008 in UL. As can be observed from FIG. 11, ProjMPA achieves substantially the same performance of an ideal MPA.

Using the same notations as above, d_{f} denotes the total number of branches connected to each FN, N denotes the number of FNs (spreading factor), and M is the size of constellation points, and M_{P} denotes the number of projection points over each tone (for simplicity, this number is assumed to be the same for all FNs).

The number of additions, multiplications and EXP(.) calculations for the ProjMPA algorithm can be obtained from:

N_{add}=Nd_{f}(Mₚ^{d}^{_{f}}−Mₚ), (12)

Nₘᵤₗ=Nd_{f}Mₚ^{d}^{_{f}}⁻¹(d_{f}−2+Mₚ), (13)

N_{EXP}=M_{P}^{d}^{_{f}}. (14)

Similar to MPA, Max-Log MAP (MLM) can also be implemented for ProjMPA which converts multiplication to addition and the EXP(.) calculation to MAX(.) operation. Hence, we have:

N_{add}^{(MLM)}=Nd_{f}Mₚ^{d}^{_{f}}⁻¹(d_{f}−2+Mₚ), (15)

N_{MAX}^{(MLM)}=Mₚ^{d}^{_{f}}. (16)

The following tables 7 and 8 compare the complexity reduction of ProjMPA compared to MPA for four and eight point SCMA constellations (T1003 and T1008 respectively) for the original algorithm and a Max-Log MAP implementation of ProjMPA. Total complexity is defined as N_{add}+3Nₘᵤₗ+10N_{EXP} for regular implementation and N_{add}^{(MLM)}+1.5N_{MAX}^{(MLM)} for Max-Log MAP implementation.

TABLE 7
Complexity reduction of ProjMPA compared
to MPA for original implementation

| T1003 | | | T1008 | | |
|---|---|---|---|---|---|
| Saving | Saving | Total | Saving | Saving | Total |
| in Mul | in Add | Saving | in Mul | in Add | Saving |
| (%) | (%) | (%) | (%) | (%) | (%) |
| 66 | 60 | 66 | 83 | 76 | 83 |

TABLE 8
Complexity reduction of ProjMPA compared to MPA for Max-Log MAP
implementation

| | |
|---|---|
| T1003 | T1008 |

| Saving | Total | Saving | Total |
|---|---|---|---|
| in Add | Saving | in Add | Saving |
| (%) | (%) | (%) | (%) |
| 66 | 66 | 84 | 84 |

ProjMPA provides another dimension in codebook design, which is the number of projections per each tone. The lower the number of projections, the lower the receiver complexity. Even with a regular MPA implementation, lower number of projections results in less complexity due to reducing the number of EXP(.) calculations. For example, the number of EXP(.) calculations for T1008 is approximately reduced by 76% compared to a codebook with eight projections per each tone.

Reference is now made to FIG. 12 illustrating an exemplary block diagram of a SCMA/LDS-OFDM system 700 employing a detector 702 practicing principles of the present disclosure. The SCMA/LDS-OFDM system 700 has a set of users (User 1 . . . User K} transmitting data to a base station. The data from each user is forward error correction (FEC) encoded and mapped by encoding and mapping modules 701₁ . . . 701_{K}. The frequency band is divided into a set of sub-channels (subcarriers/tones). The data streams from mapping modules 701₁ . . . 701_{K}. are multiplied with the SCMA/LDS signatures by SCMA/LDS spreaders S₁ . . . S_{K} 704. The data symbols are transmitted over different subcarriers by OFDM modulation module 706 that performs serial to parallel conversion 708, an inverse fast Fourier transform (IFFT) 710, adds in a guard interval (GI) 712, and converts the data from parallel to a serial stream 714. Each generated chip from User 1 . . . User K is transmitted over a subcarrier of the OFDM system radio channel 1 . . . radio channel K.

The receiver 715 receives the received signal with Additive White Gaussian Noise (AWGN). The OFDM Demodulation module 716 removes the guard interval (GI) 718, converts the data stream from serial to parallel 720, and performs a fast Fourier transform (FFT) 722 on the data. The SCMA/LDS detector module 702 receives the data from the fast Fourier transform (FFT) 722 output. The output of SCMA/LDS detector module 702 is coupled to FEC decoders 724₁ . . . 724_{K}. The output of FEC decoders 724₁ . . . 724_{K} may be fed back to the SCMA/LDS detector module 702 to enable MPA outer-loop detection.

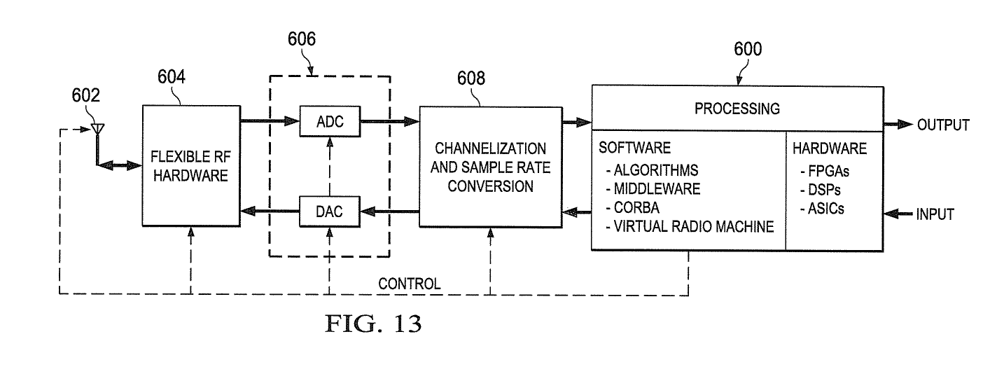

Reference is now made to FIG. 13 illustrating an exemplary block diagram of a system for practicing principles of the present disclosure.

A processing module 600 performs radio baseband functions preferably using Digital Signal Processors (DSPs), Field Programmable Gate Arrays (FPGAs), Application Specific Integrated Circuits (ASICs), general purpose processors, software, or a combination thereof. The algorithms used to modulate and demodulate the input and outputs signals may use a variety of methodologies, including but not limited to, middleware, e.g., common object request broker architecture (CORBA), or virtual radio machines, which are similar in function to JAVA virtual machines. Processing module 600 performs the methods of low complexity detection in a multicarrier, multiple access code method, in accordance with principles of the present disclosure.

An antenna or antennas 602 provides gain versus direction characteristic to minimize interference, multipath, and noise.

The RF signal is picked up by the antenna(s) 602, filtered, amplified with a low noise amplifier (LNA), and down converted with a local oscillator (LO) to baseband (or IF) by flexible RF hardware 604. The incoming signal is digitizing with an analog to digital converter (ADC) 606. Similarly, an outgoing digital signal is converted to analog by digital to analog converter (DAC) 606. Digital filtering (channelization) and sample rate conversion are provided by module 608 to interface the output of the ADC 606 to the processing module 600. Likewise, module 608 provides digital filtering and sample rate conversion to interface the processing module 600 that creates the modulated waveforms to the digital to analog converter 606.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. In a receiver, a method of low complexity multiple access code detection comprising:
receiving a signal over an antenna, the signal containing data multiplexed over a set of subcarriers according to a multiple access code system; and
decoding, by a processor, the signal in accordance with a clustered message passing algorithm (MPA), wherein the clustered MPA corresponds to one or more sub-graphs, each of the one or more sub-graphs including fewer variable node to function node (VN-to-FN) branches for at least one function node than an underlying factor graph representative of multiplexed codes for the multiple access code system.

2. (canceled)

3. The method of claim 1 wherein the multiple access code system is a multicarrier system.

4. The method of claim 3 wherein the multicarrier system is an orthogonal frequency division multiple access (OFDMA) system.

5. The method of claim 1 wherein the multiple access code system is a sparse code multiple access (SCMA) system.

6. The method of claim 1 wherein the multiple access code system is a low density signature (LDS) system.

7. The method of claim 1 wherein the one or more sub-graphs are selected such that the least number of VN-to-FN branches connect to each function node in the one or more sub-graphs while performance loss compared to a full message passing algorithm is limited to a certain threshold.

8. The method of claim 7 wherein decoding the signal in accordance with the clustered MPA includes performing MPA detection on a given one of the one or more sub-graphs by passing information from variable nodes to function nodes over VN-to-FN branches of the given sub-graph without passing information from variable nodes to functions over VN-to-FN branches of the underlying factor graph that are excluded from the given sub-graph.

9. The method of claim 1 wherein the one or more sub-graphs are sub-graphs having maximum length of a shortest cycle.

10. The method of claim 1 wherein the sub-graphs include all variable nodes included in the underlying factor graph representative of the multiple access code system.

11. The method of claim 1 wherein the one or more sub-graphs are sub-graphs with symmetrical structures.

12. The method of claim 1 wherein a detection algorithm is run for a predetermined number of iterations on each of the one or more sub-graphs.

13.-14. (canceled)

15. The method of claim 12 wherein the detection algorithm uses a Max-Log MAP algorithm.

16. An apparatus comprising:
a receiver configured to receive a signal over an antenna, the signal containing data multiplexed over a set of subcarriers according to a multiple access code system; and
a processor configured to decode the signal in accordance with a clustered message passing algorithm (MPA), wherein the clustered MPA corresponds to one or more sub-graphs, each of the one or more sub-graphs including fewer variable node to function node (VN-to-FN) branches for at least one function node than an underlying factor graph representative of the multiple access code system.

17. (canceled)

18. The apparatus of claim 16 wherein the multiple access code system is a multicarrier system.

19. The apparatus of claim 18 wherein the multicarrier system is an orthogonal frequency division multiple access (OFDMA) system.

20. The apparatus of claim 16 wherein the multiple access code system is a sparse code multiple access (SCMA) system.

21. The apparatus of claim 16 wherein the multiple access code system is a low density signature (LDS) system.

22. The apparatus of claim 16 wherein the one or more sub-graphs are selected such that the least number of VN-to-FN branches connect to each function node in the one or more sub-graphs while performance loss compared to a full message passing algorithm is limited to a certain threshold.

23. The apparatus of claim 16 wherein the one or more sub-graphs are sub-graphs having maximum length of a shortest cycle.

24. The apparatus of claim 16 wherein the one or more sub-graphs include all variable nodes included in the underlying factor graph representative of the multiple access code system.

25. The apparatus of claim 16 wherein the one or more sub-graphs are sub-graphs with symmetrical structures.

26. The apparatus of claim 16 wherein a detection algorithm is run for a predetermined number of iterations on each of the one or more sub-graphs.

27.-28. (canceled)

29. The apparatus of claim 22 wherein decoding the signal in accordance with the clustered MPA includes performing MPA detection on a given one of the one or more sub-graphs by passing information from variable nodes to function nodes over VN-to-FN branches of the given sub-graph without passing information from variable nodes to functions over VN-to-FN branches of the underlying factor graph that are excluded from the given sub-graph.

30. The apparatus of claim 26 wherein the detection algorithm uses a Max-Log MAP algorithm.

31.-45. (canceled)

46. The apparatus of claim 16, wherein decoding the signal in accordance with the clustered MPA includes rotating between the one or more sub-graphs for a predetermined number of rotation cycles.

47. The apparatus of claim 46 wherein rotating between the one or more sub-graphs for a predetermined number of rotation cycles comprises rotating between the one or more sub-graphs according to a predefined sequence.

48. The apparatus of claim 46 wherein rotating between the one or more sub-graphs for a predetermined number of rotation cycles comprises rotating between the one or more sub-graphs according to a random sequence.

49. The method of claim 1 wherein decoding the signal in accordance with the clustered MPA includes rotating between the one or more sub-graphs for a predetermined number of rotation cycles.

50. The method of claim 49 wherein rotating between the one or more sub-graphs for a predetermined number of rotation cycles comprises rotating between the one or more sub-graphs according to a predefined sequence.

51. The method of claim 49 wherein rotating between the one or more sub-graphs for a predetermined number of rotation cycles comprises rotating between the one or more sub-graphs according to a random sequence.

52. A computer program product comprising a non-transitory computer readable storage medium storing programming, the programming including instructions to:
receive a signal over an antenna, the signal containing data multiplexed over a set of subcarriers according to a multiple access code system; and
decode the signal in accordance with a clustered message passing algorithm (MPA), wherein the clustered MPA corresponds to one or more sub-graphs, each of the one or more sub-graphs including fewer variable node to function node (VN-to-FN) branches for at least one function node than an underlying factor graph representative of the multiple access code system.

53. The computer program produce of claim 52, wherein the multiple access code system is a multicarrier system.

54. The computer program produce of claim 53 wherein the multicarrier system is an orthogonal frequency division multiple access (OFDMA) system.

55. The computer program produce of claim 52 wherein the multiple access code system is a sparse code multiple access (SCMA) system.

56. The computer program produce of claim 52 wherein the multiple access code system is a low density signature (LDS) system.

57. The computer program produce of claim 52 wherein the one or more sub-graphs are selected such that the least number of VN-to-FN branches connect to each function node in the one or more sub-graphs while performance loss compared to a full message passing algorithm is limited to a certain threshold.

58. The computer program produce of claim 57 wherein the instructions to decode the signal in accordance with the clustered MPA includes instructions to perform MPA detection on a given one of the one or more sub-graphs by passing information from variable nodes to function nodes over VN-to-FN branches of the given sub-graph without passing information from variable nodes to functions over VN-to-FN branches of the underlying factor graph that are excluded from the given sub-graph.

59. The computer program produce of claim 52 wherein the one or more sub-graphs are sub-graphs having maximum length of a shortest cycle.

60. The computer program produce of claim 52 wherein the sub-graphs include all variable nodes included in the underlying factor graph representative of the multiple access code system.

61. The computer program produce of claim 52 wherein the one or more sub-graphs are sub-graphs with symmetrical structures.

62. The computer program produce of claim 52 wherein a detection algorithm is run for a predetermined number of iterations on each of the one or more sub-graphs.

63. The computer program produce of claim 62 wherein the detection algorithm uses a Max-Log MAP algorithm.

64. The computer program produce of claim 52 wherein the instructions to decode the signal in accordance with the clustered MPA include instructions to rotate between the one or more sub-graphs for a predetermined number of rotation cycles.

65. The computer program produce of claim 64 wherein the instructions to rotate between the one or more sub-graphs for a predetermined number of rotation cycles include instructions to rotate between the one or more sub-graphs according to a predefined sequence.

66. The computer program produce of claim 64 wherein the instructions to rotate between the one or more sub-graphs for a predetermined number of rotation cycles include instructions to rotate between the one or more sub-graphs according to a random sequence.
